(19) United States
(12) Patent Application Publication
(10) Pub. No.: US 2014/0232658 A1
(43) Pub. Date: Aug. 21, 2014

(54) TOUCH PANEL

(71) Applicant: TA LIANG TECHNOLOGY CO., LTD., Pa-Ter (TW)

(72) Inventors: Shang-Shu CHEN, Pa-Ter (TW); Yun-Chuan CHEN, Pa-Ter (TW)

(73) Assignee: TA LIANG TECHNOLOGY CO., LTD., Pa-Ter (TW)

(21) Appl. No.: 13/769,374

(22) Filed: Feb. 17, 2013

(51) Int. Cl. G06F 3/041

(52) U.S. Cl. CPC G06F 3/041
USPC 345/173

(57) ABSTRACT

A touch panel includes a substrate, a conducting layer, and a back plate sandwiched between the substrate and the conducting layer and including a pattern layer made out of an opaque material and a filler layer made out of a light transmissive material and filled in the pattern layer. The thickness of the pattern layer of the back plate is larger than the thickness of the filler layer so that a clearance smaller than the thickness of the conducting layer is defined between the bottom wall of the pattern layer and the bottom wall of the filler layer and facing toward the conducting layer to prevent breaking of the conducting layer when the conducting layer is compressed by an external pressure.

### BACKGROUND OF THE INVENTION

1. Field of the Invention

The present invention relates to touch screen technology and more particularly, to a touch panel for use in a touch screen.

2. Description of the Related Art

Referring to FIG. 1, a conventional touch panel 50 generally comprises a substrate 51, a pattern layer 52 printed on a part of the bottom side of the substrate 51, and a conducting layer 53 covered over the other part of the bottom side of the substrate 51 and the bottom side of the pattern layer 52. Due to the effect of the thickness of the pattern layer 52, a clearance is left between the substrate 51 and the pattern layer 52. During installation of the touch panel 50 to make a display screen, the conducting layer 53 may be compressed against the border edge of the pattern layer 52 accidentally, causing damage and leading to failure of the conducting layer 53. In consequence, the display screen yield rate will be lowered. Therefore, all related parties are anxious to find a way to solve the problems and drawbacks of the above-mentioned conventional design.

### SUMMARY OF THE INVENTION

The present invention has been accomplished under the circumstances in view. It is one object of the present invention to provide a touch panel, which uses a back plate including a pattern layer and a filler layer filled in the pattern layer to support a conducting layer, preventing breaking of the conducting layer during installation of the touch panel to make a display screen and improving display screen yield rate.

To achieve this and other objects of the present invention, a touch panel comprises a substrate, a back plate, and a conducting layer. The back plate is mounted at one side of the substrate. Further, the back plate comprises a pattern layer made out of an opaque material, and a filler layer made out of a light transmissive material and filled in the pattern layer. The conducting layer is mounted at one side of the back plate opposite to the substrate.

In one embodiment of the present invention, the thickness of the pattern layer of the back plate is larger than the thickness of the filler layer so that a clearance is defined between the bottom wall of the pattern layer and the bottom wall of the filler layer. This clearance is smaller than the thickness of the conducting layer.

In another embodiment of the present invention, the thickness of the pattern layer of the back plate is equal to the thickness of the filler layer so that the bottom wall of the pattern layer and the bottom wall of the filler layer are kept in flush with each other, forming a planar surface that supports the conducting layer.

In still another embodiment of the present invention, the thickness of the filler layer of the back plate is larger than the thickness of the pattern layer. Further, the filler layer comprises a planar bottom wall covered over the pattern layer and adapted to support the conducting layer.

Further, the light transmissive material of the filler layer of the back plate of the touch panel can be an organic UV absorber.

### DESCRIPTION OF THE DRAWINGS

FIG. 1 is a sectional side view of a touch panel according to the prior art.

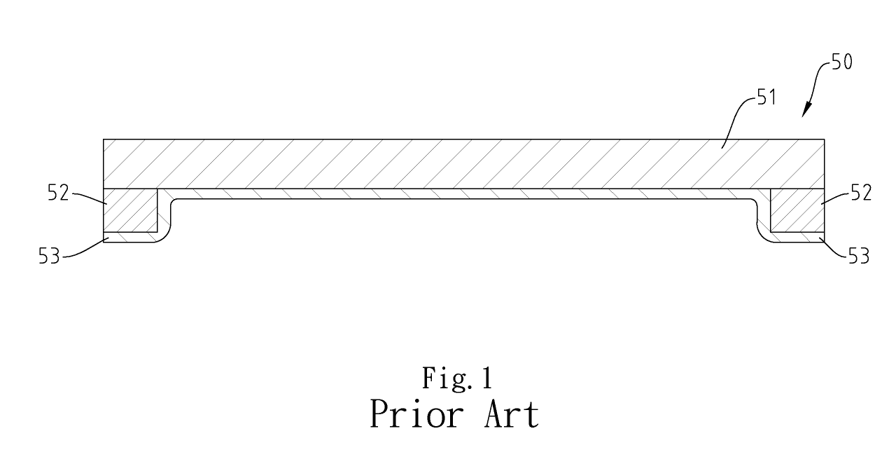

FIG. 2 is a sectional side view of a touch panel in accordance with a first embodiment of the present invention.

FIG. 3 is a sectional side view of a touch panel in accordance with a second embodiment of the present invention.

FIG. 4 is a sectional side view of a touch panel in accordance with a third embodiment of the present invention.

### DETAILED DESCRIPTION OF THE PREFERRED EMBODIMENT

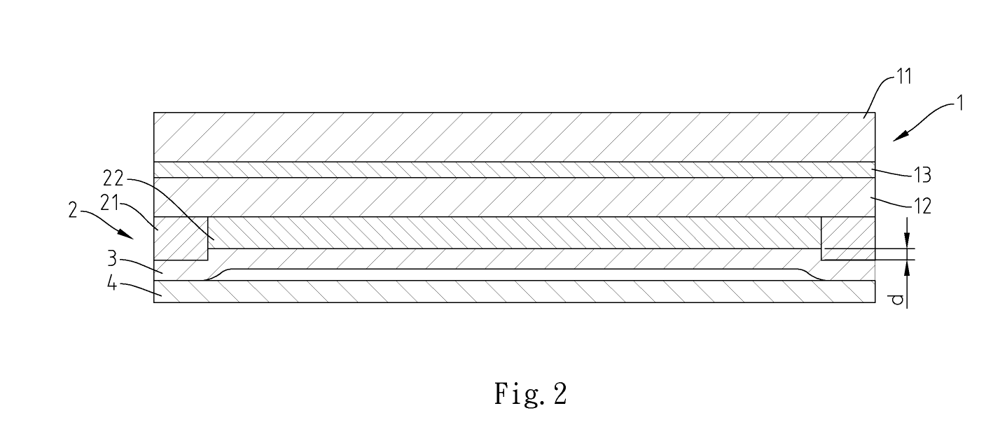

Referring to FIG. 2, a touch panel in accordance with a first embodiment of the present invention is shown. The touch panel comprises a substrate 1, a back plate 2, a conducting layer 3, and a protective film 4.

The substrate 1 comprises a glass cover plate 11, a plate filter 12, and an optically clear adhesive (OCA) 13 sandwiched between the glass cover plate 11 and the plate filter 12 to bond them together.

The back plate 2 is attached to the plate filter 12 of the substrate 1 opposite to the glass cover plate 11, comprising a pattern layer 21 made out of an opaque material, for example, opaque ink, and a filler layer 22 made out of a light transmissive material, for example, organic UV absorber. The thickness of the pattern layer 21 is larger than the thickness of the filter layer 22 so that a clearance d is left between the bottom wall of the pattern layer 21 and the bottom wall of the filler layer 22.

The conducting layer 3 is covered on one side of the pattern layer 21 and filler layer 22 of the back plate 2 opposite to the plate filter 12 of the substrate 1. The conducting layer 3 is made out of silver (Ag) or graphite. The thickness of the conducting layer 3 is larger than the clearance d between the bottom wall of the pattern layer 21 and the bottom wall of the filler layer 22.

The protective film 4 is covered on one side of the conducting layer 3 opposite to the back plate 2. Further, the protective film 4 is made out of thermoplastic polymers, for example, polyethylene terephthalate.

Thus, when the conducting layer 3 is compressed by an external pressure, due to that the clearance d between the wall of the pattern layer 21 and the bottom wall of the filler layer 22 is smaller than the thickness of the conducting layer 3, the deformable range of the conducting layer 3 at the pattern layer 21 and filler layer 22 of the back plate 2 is smaller than the thickness of the conducting layer 3 itself, i.e., the conducting layer 3 will be supported by the filler layer 22 when it is compressed, avoiding breaking of the conducting layer 3 and improving the yield of the display screen. Further, because the filler layer 22 is made out of an organic UV absorber, the invention greatly improves the transmittance of the touch panel.

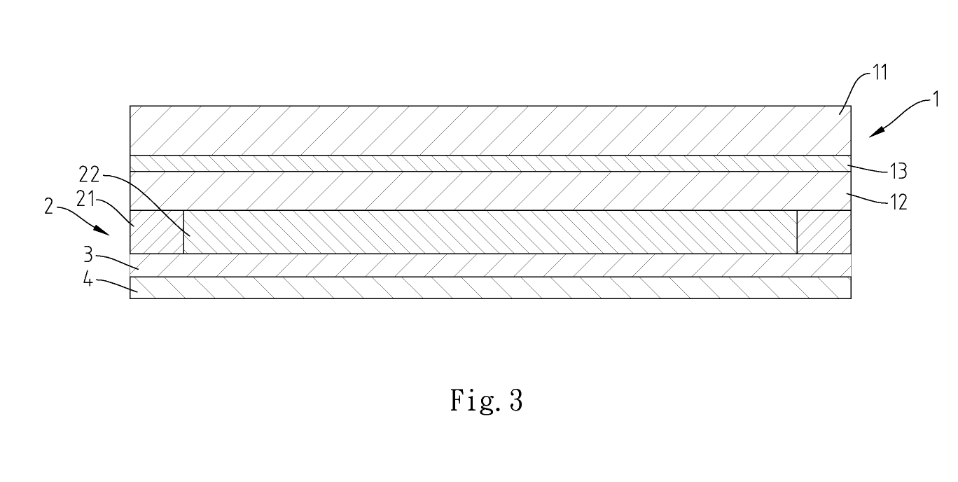

Referring to FIG. 3, a touch panel in accordance with a second embodiment of the present invention is shown. The touch panel in accordance with this second embodiment is substantially similar to the aforesaid first embodiment with the exception that the thickness of the pattern layer 21 of the back plate 2 is equal to the thickness of the filler layer 22 so that the bottom wall of the pattern layer 21 is kept in flush with the bottom wall of the filler layer 22, forming a planar surface in close contact with the conducting layer 3. Thus, when the conducting layer 3 is compressed by an external pressure, the planar surface that is formed of the bottom wall of the pattern layer 21 and the bottom wall of the filler layer 22 supports the conducting layer 3 against deformation, avoiding breaking of the conducting layer 3.

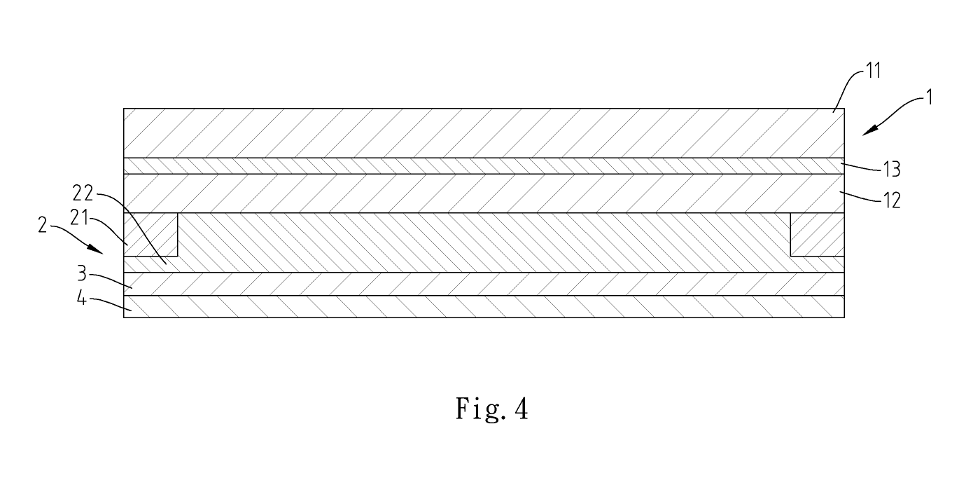

Referring to FIG. 4, a touch panel in accordance with a third embodiment of the present invention is shown. The touch panel in accordance with this third embodiment is substantially similar to the aforesaid second embodiment with the exception that the thickness of the filler layer 22 of the back plate 2 is larger than the thickness of the pattern layer 21; the pattern layer 21 is covered by the planar bottom wall of the filler layer 22; the conducting layer 3 is mounted at the planar bottom wall of the filler layer 22. Thus, when the conducting layer 3 is compressed by an external pressure, the planar bottom wall of the pattern layer 21 supports the conducting layer 3 against deformation, avoiding breaking of the conducting layer 3.

What the invention claimed is:

1. A touch panel, comprising a substrate, a back plate mounted at one side of said substrate, and a conducting layer mounted at one side of said back plate opposite to said substrate, said back plate comprising a pattern layer made out of an opaque material and a filler layer made out of a light transmissive material and filled in said pattern layer.

2. The touch panel as claimed in claim 1, wherein the thickness of said pattern layer is larger than the thickness of said filler layer so that a clearance is defined between a bottom wall of said pattern layer and a bottom wall of said filler layer and facing toward said conducting layer; said conducting layer is mounted at the bottom wall of said pattern layer and the bottom wall of said filler layer.

3. The touch panel as claimed in claim 2, wherein said clearance is smaller than the thickness of said conducting layer.

4. The touch panel as claimed in claim 1, wherein the thickness of said pattern layer of said back plate is equal to the thickness of said filler layer; said pattern layer comprises a bottom wall; said filler layer comprises a bottom wall kept in flush with the bottom wall of said pattern layer; said back plate comprises a planar surface formed of the bottom all of said pattern layer and the bottom wall of said filler layer; said conducting layer is supported on said planer surface of said back plate.

5. The touch panel as claimed in claim 1, wherein the thickness of said filler layer of said back plate is larger than the thickness of said pattern layer; said filler layer comprises a planar bottom wall covered over said pattern layer to support said conducting layer.

6. The touch panel as claimed in claim 1, wherein light transmissive material of said filler layer is an organic UV absorber.
